(19) United States
(12) Patent Application Publication
(10) Pub. No.: US 2015/0189411 A1
(43) Pub. Date: Jul. 2, 2015

(54) System and Method for Supporting One or More Speakers Using a Bendable Connector

(71) Applicant: Michael Andrich, Houston, TX (US)

(72) Inventor: Michael Andrich, Houston, TX (US)

(21) Appl. No.: 14/141,288

(22) Filed: Dec. 26, 2013

(51) Int. Cl. H04R 1/02

(52) U.S. Cl. CPC H04R 1/02

(57) ABSTRACT

A system for supporting one or more speakers using a bendable connector is herein disclosed. The system can comprise a bendable connector having a first end connectable to a first speaker. The connector can be capable of substantially retaining its shape. In one embodiment, the connector can comprise a second end that is connectable to a second speaker.

### BACKGROUND

This disclosure relates to a system for supporting one or more speakers using a bendable connector.

Traditionally, most portable speakers are designed to stand or be placed on top of a flat surface. However, flat surfaces are not always accessible. Therefore limiting the places or ways portable speakers can be mounted. Additionally, most portable speakers are connected to an audio source through a wire. Thus, moving wired portable speakers means the audio source has to be moved with it. This method can work if the audio source being used is also portable. However, in situations wherein an audio source is running from a fixed location such as a desktop computer, this kind of setup can be inconvenient. Moreover, cables from wired portable speakers can look unsightly and adds to the clutter. Furthermore, standard portable speakers are configured to stay in one area when in use. Thus, when a person needs to move around the speakers are usually left in the place of installation. However, there are some Bluetooth speakers that can be wirelessly connected to an audio source and be carried by hands to be taken from one location to another. This method can be effective only in situations wherein the user's hands are not in use and can be very inconvenient especially when an individual needs to move around with his hands free from any object. As such it would be useful to have a system for supporting one or more speakers using a bendable connector.

### SUMMARY

A system for supporting one or more speakers using a bendable connector is herein disclosed. The system can comprise a bendable connector having a first end connectable to a first speaker. The connector can be capable of substantially retaining its shape. In one embodiment, the connector can comprise a second end that is connectable to a second speaker.

### BRIEF DESCRIPTION OF THE DRAWINGS

FIG. 1 illustrates a speaker system comprising a pair of speakers, and a connector.

FIG. 2A illustrates an embodiment of a connector.

FIG. 2B illustrates another embodiment of a connector comprising a first portion and a second portion.

FIG. 3A illustrates an embodiment of a connector as an audio jack.

FIG. 3B illustrates an embodiment of a connector as a USB port.

FIG. 4A illustrates an embodiment of a joint comprising a magnetic material.

FIG. 4B illustrates an embodiment of a joint comprising a threaded port.

FIG. 5 illustrates an exploded view of a speaker.

FIG. 6A illustrates a speaker system mounted to an object.

FIG. 6B illustrates a speaker system used as a wearable device.

FIG. 7A illustrates an electrical connection diagram for a speaker system.

FIG. 7B illustrates an electrical connection diagram for a speaker system, wherein a first speaker is wirelessly connected to a second speaker.

FIG. 7C illustrates an electrical connection diagram for a speaker system, wherein a first speaker is wired to a second speaker.

FIG. 8A illustrates an embodiment of a cover.

FIG. 8B illustrates another embodiment of a cover.

FIG. 9A illustrates an embodiment of a connector.

FIG. 9B illustrates another embodiment of a connector comprising a sleeve.

### DETAILED DESCRIPTION

Described herein is a system and method for supporting one or more speakers using a bendable connector. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

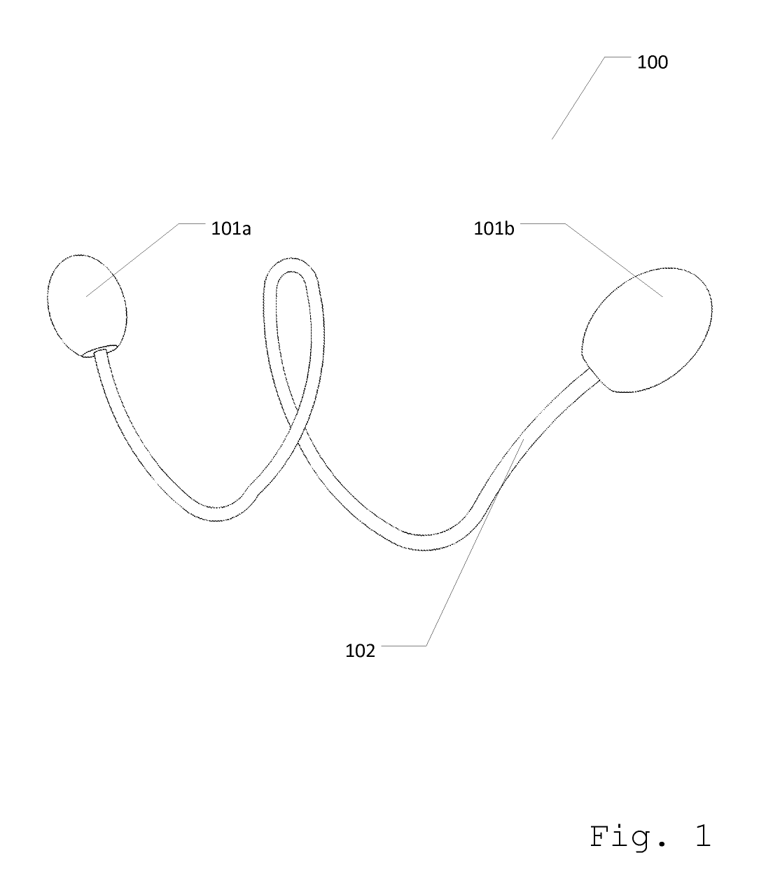

FIG. 1 illustrates a speaker system 100 comprising a pair of speakers 101, and a connector 102. Speakers 101 can be wirelessly connected to any compatible wireless audio player or electronic devices, such as a cell phone. In one embodiment, speakers 101 can utilize Bluetooth technology that allows speakers 101 to be paired with any Bluetooth capable devices. In another embodiment, speakers 101 can use other wireless technology such as Wi-Fi technology. Connector 102 can be bent in different forms or wrapped to any desired position. As such, connector 102 can be bent into a stand for speakers 101. Furthermore, connector 102 can comprise of stiff material such as, aluminum and copper or any other material known in the art that allows connector 102 to bend easily but still able to keep its shape. In such structure, connector 102 can hold speakers 101 in a desired position. Thus, connector 102 can be capable of substantially retaining its shape. Moreover, connector 102 can be mounted on uneven surfaces or wrapped around any irregular object to hold speakers 101 in place. In one embodiment, connector 102 can be used to attach speakers 101 together. In another embodiment, connector 102 can be used to channel audio signals between speakers 101. Further in one embodiment, connector 102 can be a single device connectable to speakers 101. As such, connector 102 can comprise a solid body. In another embodiment, connector 102 can be split at the middle forming two separate connectors 102.

In one embodiment, speakers 101 can be individual wireless speakers. In such embodiment, each speaker 101 can work independently and separate from each other, or in stereo. This setup allows a 3-way Bluetooth audio connection, which is connection between two speakers 101 and connection of two speakers 101 with any Bluetooth capable device. In another embodiment, only one of speaker 101 can be wirelessly capable of connecting to an electronic device. As such, a first speaker 101a can wirelessly share the audio signals to a second speaker 101b. Thus, second speaker 101b can be dependent with first speaker 101a. After speakers 101 are paired together, speaker 101 can then be paired with the desired wireless device. Furthermore in such setup, first speaker 101a can receive the audio stream from a wireless capable device and then transmit it to second speaker 101b. In another embodiment, first speaker 101a can share the audio signals to second speaker 101b through connector 102. In this embodiment, connector 102 can comprise of electrical wiring that is capable of transmitting audio signals to second speaker 101b. Further in another embodiment, another speaker system 100 can be paired with the initial speaker system 100. As such, two or more speakers 101 can play the same music simultaneously or different portions of music simultaneously (stereo).

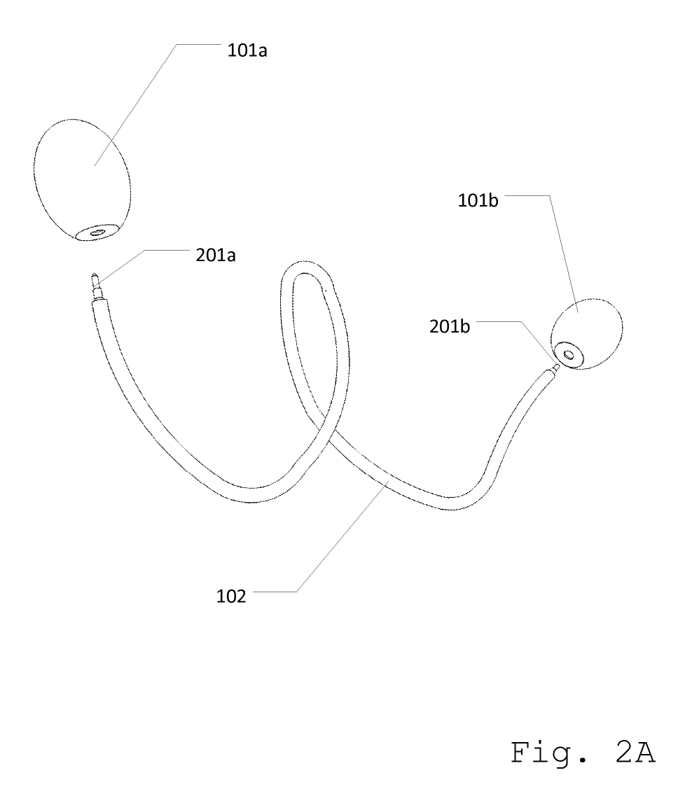

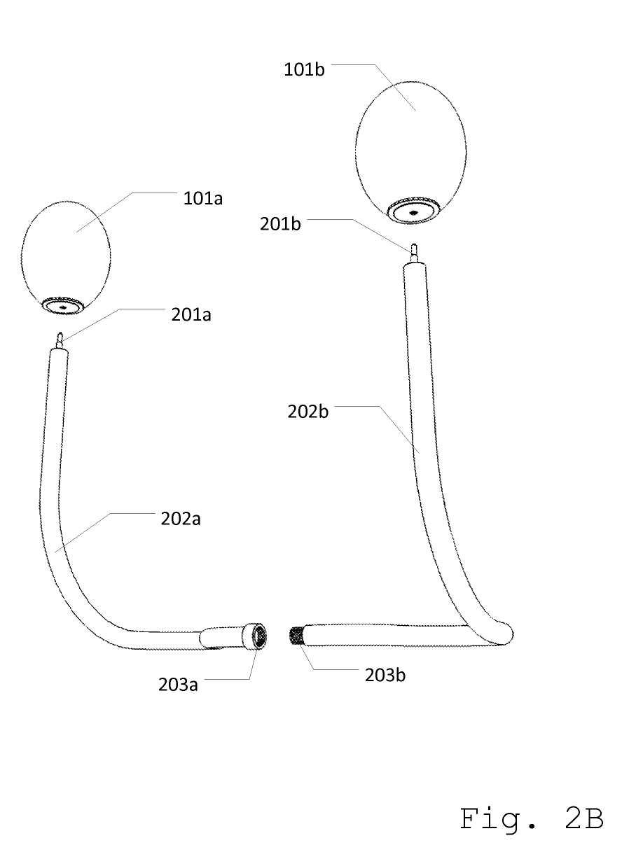

FIG. 2A illustrates an embodiment of connector 102. In one embodiment, first end 201a can be connectable to first speaker 101a. In this embodiment, first speaker 101a can be detachable from first end 201a. Moreover in this embodiment, first speaker 101a can connect wirelessly with an audio source.

In another embodiment, connector 102 can further comprise a second end 201b that can be connectable to second speaker 101b. In such embodiment, first speaker 101a can be connected to first end 201a while second speaker 101b can be connected to second end 201b. As such, first speaker 101a can be detachable from first end 201a and second speaker 101b can be connected to second end 201b. In one embodiment, first speaker 101a can connect wirelessly with an audio source and can transmit an audio signal to second speaker 101b by a hardwired electrical connection. Thus in such structure, hardwired electrical connection can be placed within connector 102. In another embodiment, first speaker 101a can transmit audio signals to second speaker 101b wirelessly. In such embodiments, connector 102 comprises an electrical connection between first end 201a and second end 201b. As such, first speaker 101a can be electrically connected to second speaker 101b.

FIG. 2B illustrates another embodiment of connector 102 comprising a first portion 202a and a second portion 202b. In this embodiment, connector 102 can split in to two. As such, a first joint 203a and a second joint 203b can be placed at the middle of connector 102 wherein the split is formed. In one embodiment first end 201a and second end 201b can be can be permanently attached to each speaker 101. In another embodiment, first end portion 201a and second end portion 201b can be detachable from each speaker 101. Further in such structure, first portion 202a can comprise first joint 203a while second portion 202b can comprise a second joint 203b. First joint 203a can be compatible with second joint 203b. Furthermore, first joint 203a can be electrically connectable with second joint 203b through connector 102. Therefore in these embodiments, when speakers 101 are separated, each speaker 101 can use first portion 202a and second portion 202b as a stand or a holder. Furthermore in these embodiments, each speaker 101 can be attached interchangeably with each 201 of connector 102.

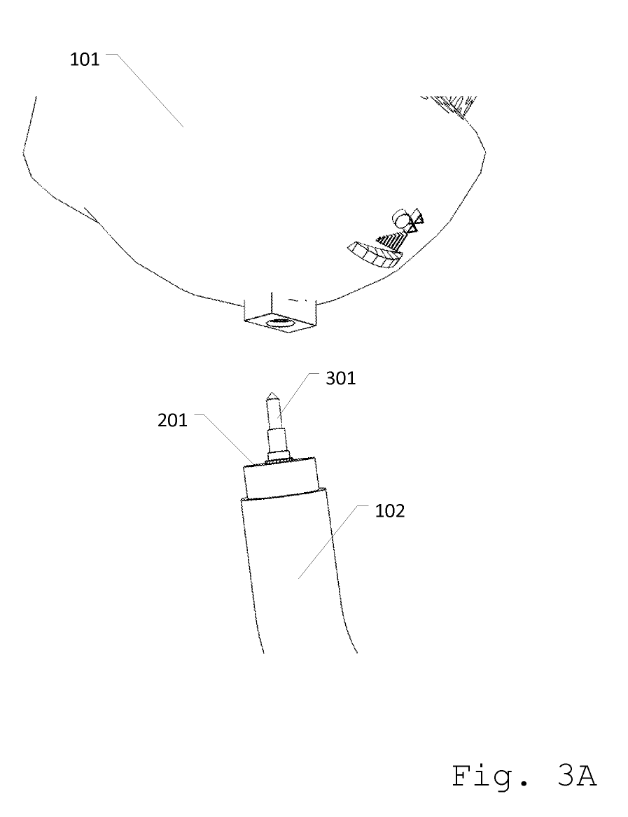

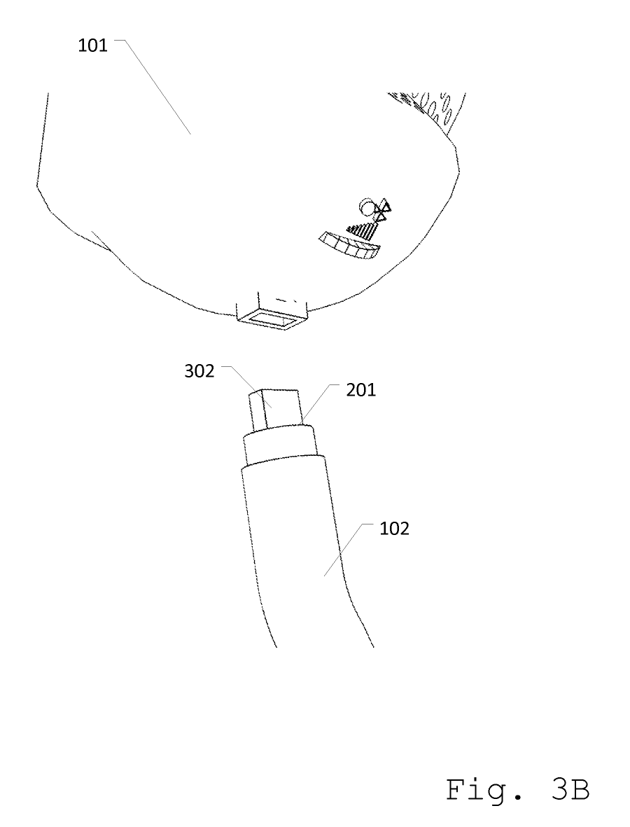

FIG. 3A illustrates an embodiment of connector 102 as an audio jack 301. In an embodiment wherein first end 201a and second end 201b can be detachable from speakers 101, first end 201a can comprise a first audio jack 301a while second end 201b can comprise a second audio jack 301b. In such embodiment, the bottom portion of each speaker 101 can comprise an audio socket compatible with audio jack 301.

FIG. 3B illustrates an embodiment of connector 102 as a USB port 302. In this embodiment, first end 201a and second end 201b can comprise USB port 302. USB port connector 302 can be any type of USB connector that can include but are not limited to standard USB plug, micro USB plug, or mini USB plug. As such, bottom portion of each speaker 101 can comprise a USB slot compatible with USB port 302.

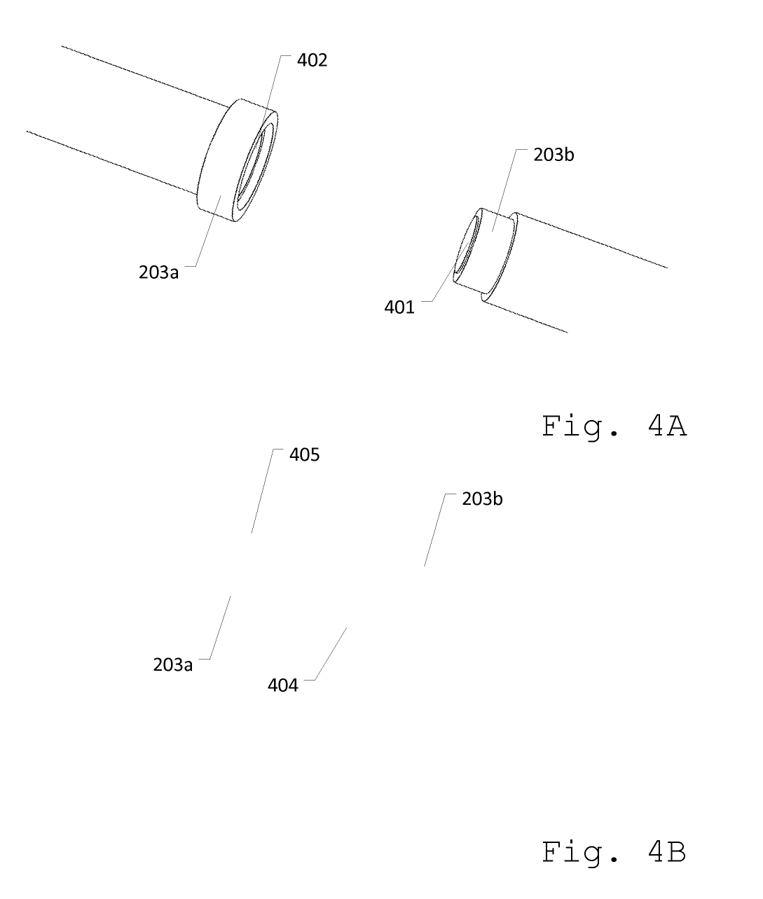

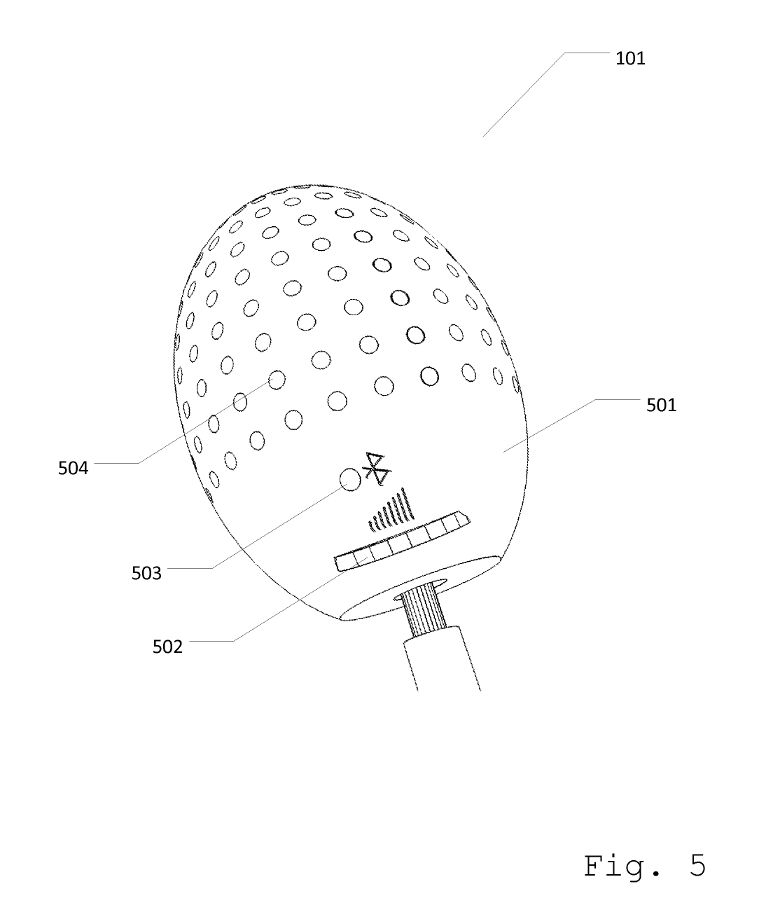

FIG. 4A illustrates an embodiment of joint 203 comprising a magnetic material 401. In an embodiment wherein connector 102 splits into two, joints 203 can be used to affix speakers 101 together. Furthermore, connector 102 can be detached from each speaker 101 and be used as a stand for each speaker 101. Thus, speakers 101 in this embodiment can be wirelessly connected and does not need any electrical and physical connection. In this embodiment, joints 203 can comprise magnetic material 401 that can allow first portion 202a and second portion 202b be mateable where the split is formed. In one embodiment, first joint 203a can comprise a slot 402 and magnetic material 401 while second joint 203b can be made of metal material. In such structure, second joint 203b can be insertable within first joint 203a such that joining magnetic material 401 and metal material on second joint 203b can provide a secure hold affixing first portion 202a with second portion 202b.

FIG. 4B illustrates an embodiment of joint 203 comprising a threaded port 404. In this embodiment, first joint 203a can comprise a threaded slot 405 that can be mateable with threaded port 404 attached to second joint 203b.

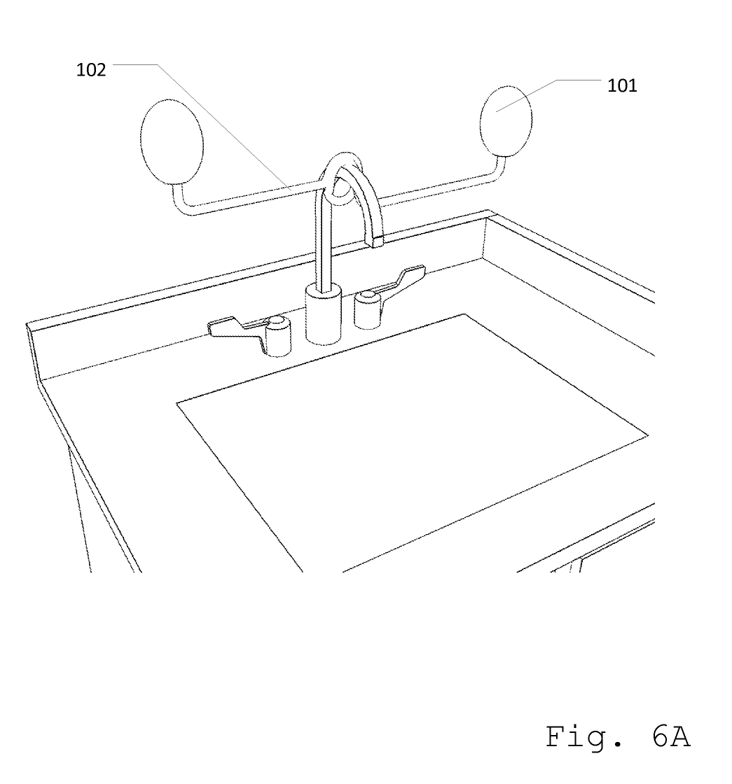

FIG. 5 illustrates an exploded view of speaker 101. Speaker 101 can comprise an enclosure 501, a plurality of function keys 502, and one or more indicators 503. Enclosure 501 can be used to mount each speaker 101. In another embodiment, enclosure 501 can be any variety of shapes. Enclosure 501 can be configured in a shape that can provide optimal sound for each speaker 101. Further, enclosure 501 can be waterproof to ensure that parts of speakers 101 are protected from any liquid substance. Furthermore, enclosure 501 can comprise a protective guard to shield speakers 101 from impacts and/or other environmental factors. Moreover, enclosure 501 can comprise a plurality of orifices 504 that serves as a vent for the sound.

Function keys 502 can be a button or a switch that provide as a control for speakers 101. Furthermore, function keys 502 can utilize touchscreen technology that can allow user to touch a desired function key to control speakers 101. As such, enclosure 501 can have a sleek and smooth surface. Further, function keys 502 can comprise a power button, and a volume control. In another embodiment, function keys 502 can comprise a play button, a stop button, a next button, and a previous button.

Indicators 503 can comprise a light-emitting diode (LED). Indicator 503 can be used to indicate if speaker 101 is powered on or off. Furthermore, indicator 503 for power on or off can also be used to indicate status of battery for speakers 101. As such, indicator 503 can use different colors to indicate battery status such as a red light can blink to show a low battery status, and a green light for a high battery status. In another embodiment, indicator 503 can be used to indicate if wireless connection has been established between speakers 101 and audio player device. Further in another embodiment, speakers 101 can comprise a separate indicator 503 for power source and wireless connection.

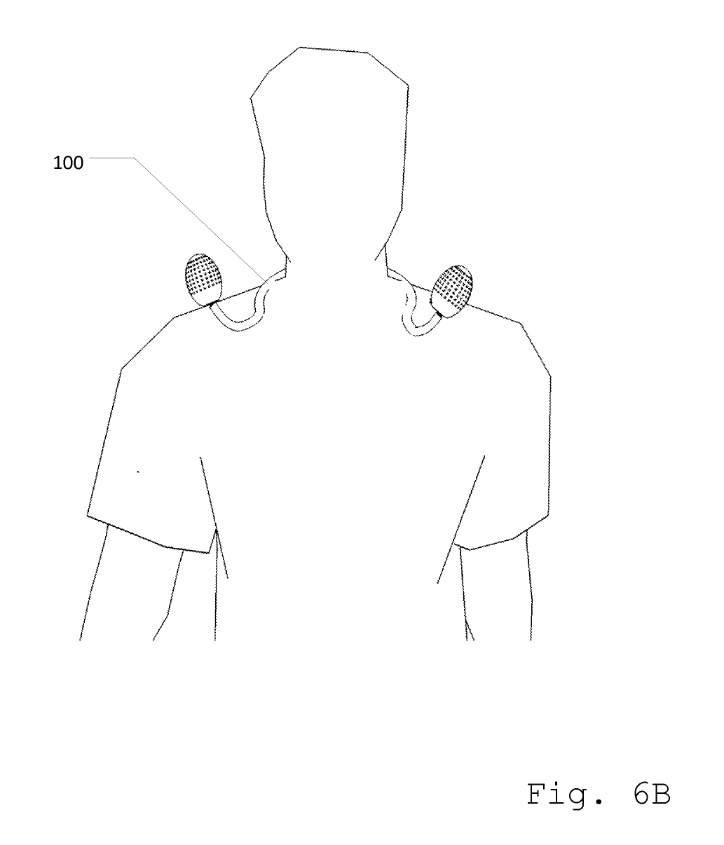

FIG. 6A illustrates speaker system 100 mounted to an object. In this embodiment, connector 102 can be used to mount speaker system 100 on any object. As such, portion of connector 102 can be wrapped around any object to hold speakers 101 in place. Furthermore, connector 102 can also be used as a stand for speakers 101. In an embodiment wherein connector 102 can split into two, each speaker 101 can use each portions of connectors 102 as a holder or a stand.

FIG. 6B illustrates speaker system 100 used as a wearable device. Speaker system 100 can also be hanged from the neck or can be wrapped around the waist, or arms. In this embodiment, speaker system 100 can be worn and used by the user while moving around. Furthermore in scenarios wherein there are no objects or areas that speaker system 100 can mount into, speaker system 100 can be worn around the user's body.

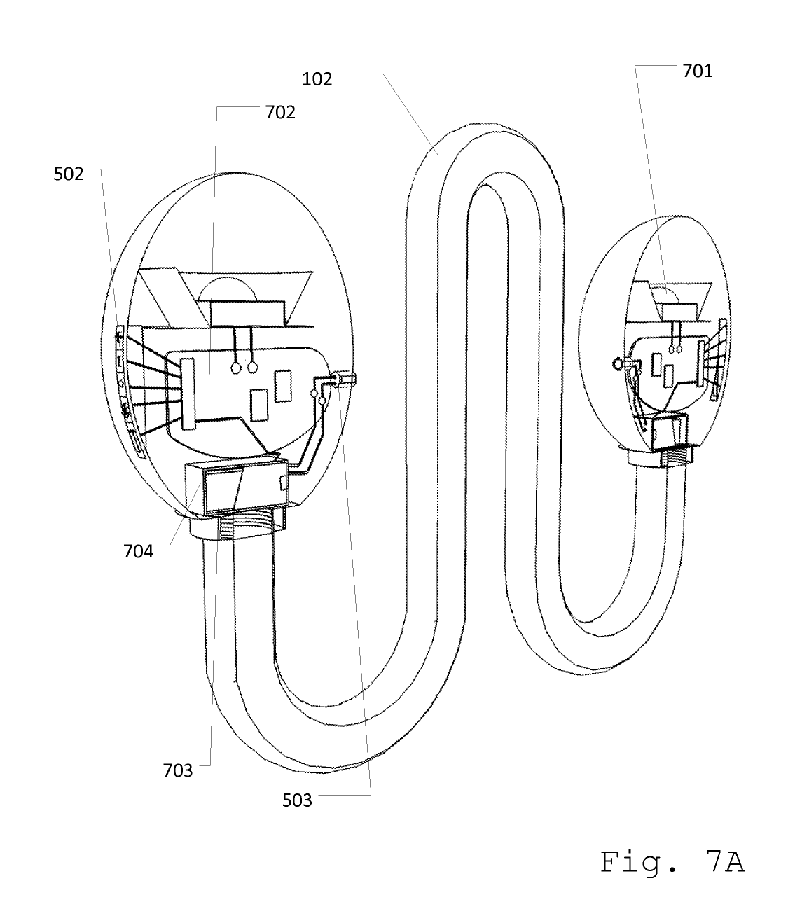

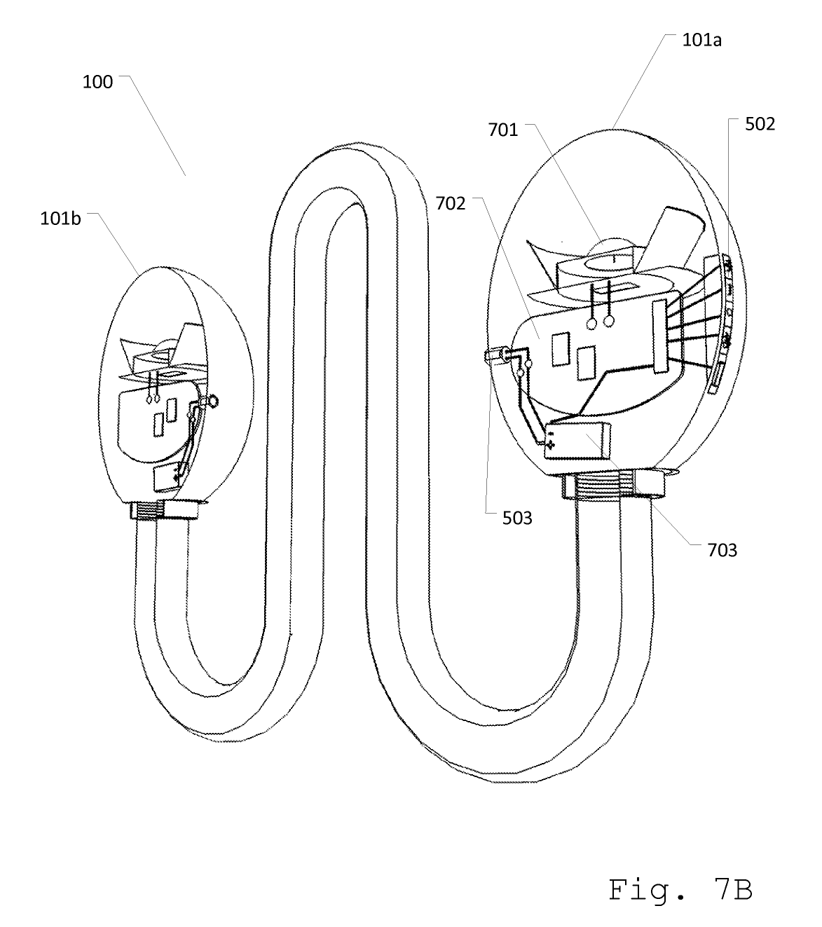

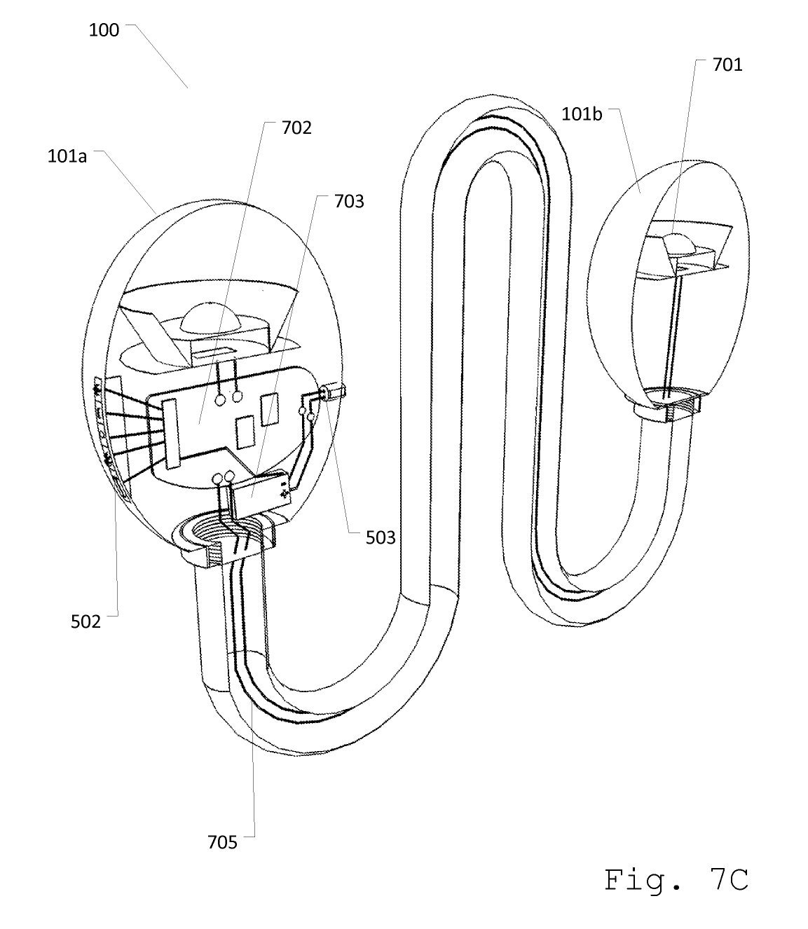

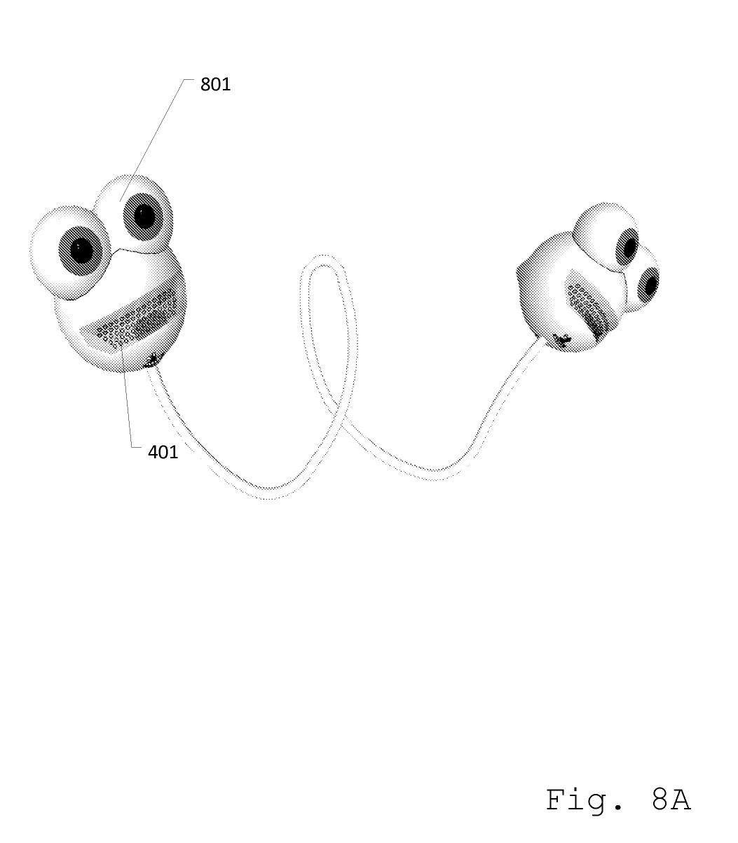

FIG. 7A illustrates an electrical connection diagram for speaker system 100, wherein each speaker 101 can be individual speakers. In this embodiment, each speaker 101 can comprise, but is not limited to, an amplifier 701, a Wireless communication module 702, a battery 703, function keys 502, and indicator 503. Audio speaker 701 can be any device that converts electrical signals into an audible sound. Wireless communication module 702 can be a hardware device that allows the sending and receiving of Bluetooth signals between devices.

Wireless communication module 702 on each speaker 101 can be Bluetooth transceivers. As such, each speaker 101 can be stand-alone and be used individually. Therefore, each speaker 101 can be wirelessly connected to different Bluetooth capable audio source. Thus in this embodiment, connector 102 can merely be used to attach speakers 101. In such embodiment, function keys 502 can be used to control each speaker 101 independently. As such, each speaker 101 can be operated independently and connected to two different audio source at the same time. Further, speakers 101 can also be paired together therefore allowing speakers 101 to be connected on a single audio source at the same time. As such, speakers 101 can play the same audio and act as a single speaker system. In this embodiment, first speaker 101a can act as a transmitter while the second speaker 101b can act as a receiver of Bluetooth signals.

FIG. 7B illustrates an electrical connection diagram for speaker system 100, wherein first speaker 101a is wirelessly connected to second speaker 101b. In this embodiment, Bluetooth modules 702 on both speakers 101 can be Bluetooth receivers. In such embodiment, speakers 101 can be wirelessly connected to each other. Thus, connector 102 can only serve as a physical connector for speakers 101. As such, each speaker 101 can comprise amplifier 701, Wireless communication module 702, and battery 703. Furthermore in such embodiment, second speaker 101b can be dependent on first speaker 101a. As such, function keys 502 and indicator 503 can be installed on first speaker 101a, such that controls and functions of second speaker 101b rely on the actuation of function keys on first speaker 101a.

FIG. 7C illustrates an electrical connection diagram for speaker system 100, wherein first speaker 101a is wired to second speaker 101b. In this embodiment, first speaker 101a can comprise amplifier 701, wireless communication module 702, battery 703, function keys 502, and indicator 503 while second speaker 101b can comprise amplifier 701. In such embodiment, second speaker 101b can only work when connected to first speaker 101a. As such, a plurality of wires 705 can be used to connect first speaker 101a and second speaker 101b. Therefore, wireless communication module 702 in first speaker 101a can be a Bluetooth receiver that shares audio signals with second speaker 101b through wires 705. In another embodiment, second speaker 101b can receive power supply from battery 703 on first speaker 101a through wires 705. Further, connector 102 in this embodiment can be used to enclose and protect wires 705. As such, connector 102 can be used as electrical connector for speakers 101. In an embodiment, wherein connector 102 is split and connected by joints 203, joints 203 can facilitate an electrical connection between wires 705 for power and/or communication transmission. Additionally, one can appreciate that both a wired and wireless communication solution between speakers can exist in one configuration with a manual or automated switching capability between the wired or wireless communication.

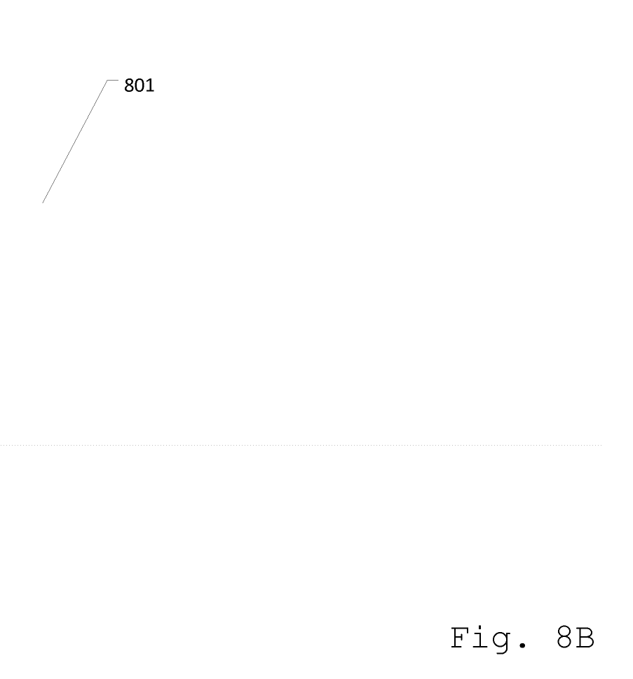

FIG. 8A illustrates an embodiment of a cover 801. In one embodiment, enclosure 501 can further comprise a cover 801. Cover 801 can be made of durable material such as plastics, silicone, rubber, or fabrics. In one embodiment, cover 801 can be configured in various shapes, colors, and texture. As such, cover 801 can be shaped into animals, and famous characters. Covers can further be made of a stretchable material such as rubber or neoprene, or can use a zipper or other fastener device to enlarge and shrink an orifice purposed for speaker 101.

FIG. 8B illustrates another embodiment of cover 801. In this embodiment, cover 801 can comprise different types of engravings or other decorative materials. The outer surface enclosure 501 can be painted, or decorated with design materials. In this example, cover 801 can be designed with different logos, such as basketball team logos, football team logos, etc.

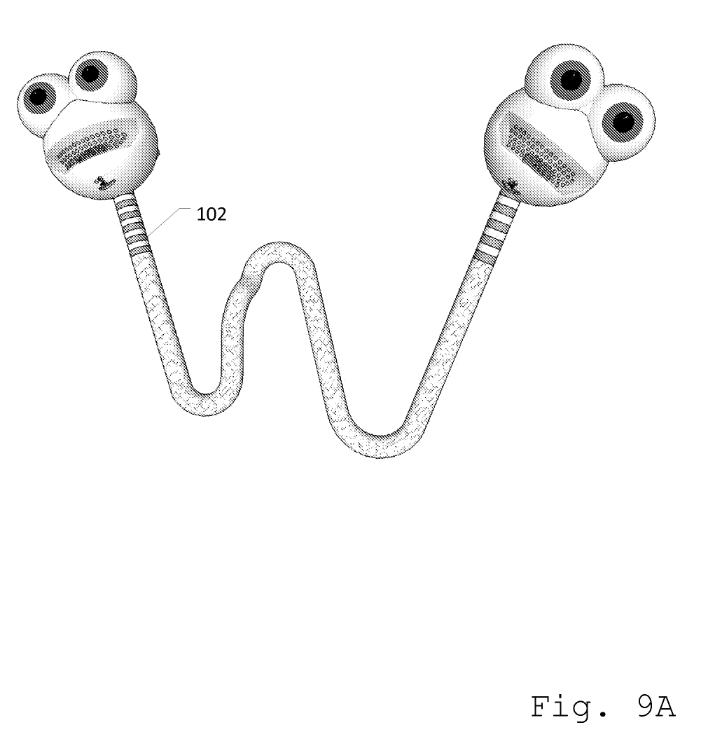

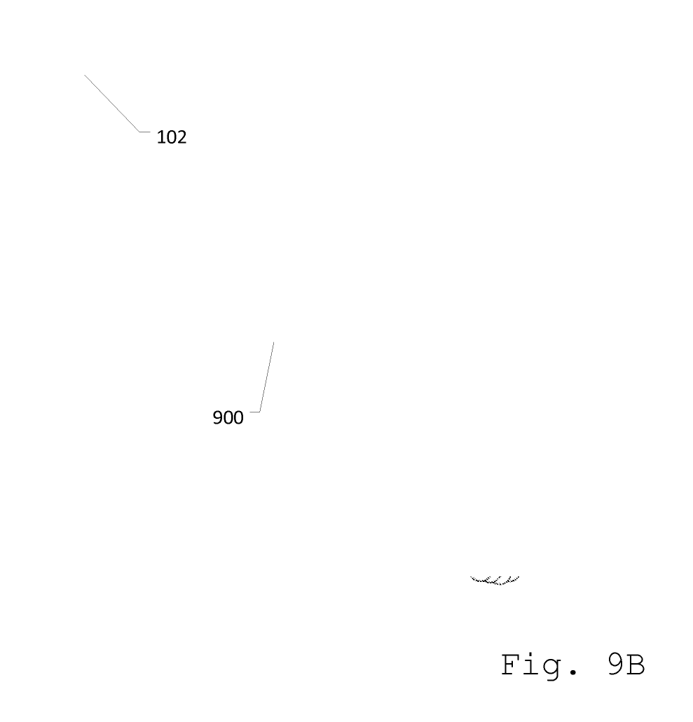

FIG. 9A illustrates an embodiment of connector 102. In this embodiment connector 102 can be configured in various diameter, shapes, and sizes. Furthermore, connector 102 can be painted, or decorated with different design patterns or colors. In one embodiment, connector 102 can be designed with different logos.

FIG. 9B illustrates another embodiment of connector 102 comprising a sleeve 900. Sleeve 900 can be used as a cover for connector 102. In one embodiment, sleeve 900 can be permanently attached to connector 102. In another embodiment, sleeve 900 can be removable from connector 102. In this embodiment, sleeve 900 can be replaced with a different sleeve. In such embodiments, sleeve 900 can comprise design materials and can be decorated with different patterns, textures, or colors. Furthermore, sleeve 900 can comprise different logos.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A system for supporting one or more speakers comprising
a bendable connector having a first end connectable to a first speaker, said connector capable of substantially retaining its shape.

2. The system of claim 1 wherein said bendable connector further comprises a second end connectable to a second speaker.

3. The system of claim 2 wherein said bendable connector comprises an electrical connection between said first end and said second end such that said first speaker can be electrically connected to said second speaker.

4. The system of claim 2 where said bendable connector comprises
a first portion comprising said first end and a first joint; and
a second portion comprising said second end and a second joint, said first joint connectable with said second joint.

5. The system of claim 4 wherein said bendable connector comprises
a first portion comprising said first end and a first joint; and
a second portion comprising said second end and a second joint, said first joint electrically connectable with said second joint.

6. The system of claim 2 wherein said first end comprises a first audio jack and said second end comprises a second audio jack.

7. The system of claim 5 wherein said first end comprises a first audio jack and said second end comprises a second audio jack.

8. The system of claim 1 comprising said first speaker connected to said first end.

9. The system of claim 8 wherein said first speaker is detachable from said first end.

10. The system of claim 2 further comprising
said first speaker connected to said first end; and
said second speaker connected to said second end.

11. The system of claim 10 wherein said first speaker is detachable from said first end, and
said second speaker is connected to said second end.

12. The system of claim 8 wherein said first speaker connects wirelessly with an audio source.

13. The system of claim 10 wherein said first speaker connects wirelessly with an audio source.

14. The system of claim 13 wherein said first speaker transmits an audio signal to said second speaker by a hardwired electrical connection within said bendable connector.

15. The system of claim 13 wherein said first speaker transmits an audio signal to said second speaker wirelessly.

16. The system of claim 1 wherein said bendable connector comprises a sleeve.

17. The system of claim 15, wherein said sleeve permanently is attached to said bendable connector.

18. The system of claim 15, wherein said sleeve is removable from said bendable connector.
